(19) United States
(12) Patent Application Publication
(10) Pub. No.: US 2024/0125507 A1
(43) Pub. Date: Apr. 18, 2024

(54) VENTILATION CONDUIT

(71) Applicant: 9415-2667 QUEBEC INC., Montreal (CA)

(72) Inventors: Philippe Forest, Montreal, QC (CA); Pierfelix Lavoie Rondeau, Montreal, QC (CA)

(21) Appl. No.: 18/547,333

(22) PCT Filed: Feb. 21, 2022
(86) PCT No.: PCT/CA2022/050247

§ 371 Date: Aug. 21, 2023

Related U.S. Application Data
(60) Provisional application No. 63/151,311, filed on Feb. 19, 2021.

(51) Int. Cl. F24F 13/02; F16L 9/147; F16L 58/10; F16L 59/14

(52) U.S. Cl. CPC F24F 13/0281; F16L 9/147; F16L 58/1009; F16L 58/1054; F16L 59/143; F24F 13/0209; F24F 13/0245

(57) ABSTRACT

A ventilation conduit is provided, the ventilation conduit being configured to be installed in a building structure with cement poured on said conduit. The ventilation conduit is configured to have a profile section comprising a plurality of layers, a first layer being of a first material and a second layer being of a second material having anti-corrosion properties. The first material may be any of galvanized steel, aluminum or stainless steel and the second material may be a polymer-based material. The layers are arranged in a configuration having periodic waves and sealing regions in a hook configuration. An anti-corrosion coating and a thermal insulation membrane may be applied on the first and second materials. A method for processing and installing a ventilation conduit is further provided, the method allowing the processing of ventilation conduits as described above.

### CROSS-REFERENCE TO RELATED APPLICATIONS

The present patent application claims the benefits of priority of U.S. Patent Application No. 63/151,311, entitled “Ventilation conduit” and filed at the United States Patent and Trademark Office on Feb. 19, 2021, the content of which is incorporated herein by reference.

### FIELD OF THE INVENTION

The present invention generally relates to ventilation systems for buildings, more precisely to air ducts installed in concrete slabs.

### BACKGROUND OF THE INVENTION

The ventilation of buildings is often done by inserting galvanized rigid pipes in slab concrete. The rigid pipes come in different length, from 4′ to 10′ and require assembly at the construction site. Because of the rigidity of the pipes, it is generally required to use adjustable elbows to install said pipes with in connection with other pipes or systems. Add to this requirement a need for assembly of various different parts for a suitable installation of the rigid pipes. For example, the rigid pipes must be screwed and sealed with a variety of adhesives and tape throughout the entirety of their length. It is further generally required that the rigid pipes be secured with steel wire to the structure assembly on the installation site. To do so, workers must manually cut a length of steel wire before attaching the rigid pipe to the structure with said steel wire.

Accordingly, there is a need for a ventilation system adapted to be installed in structure assemblies of buildings that is faster and more convenient to workers when compared to the traditional installation methods above-presented.

### SUMMARY OF THE INVENTION

The aforesaid and other objectives of the present invention are realized by generally providing a ventilation conduit section, the section comprising: a plurality of layers stacked on top of one another, the layers being made of a first material, wherein the plurality of layers define a longitudinal region having a periodic pattern along a length, the plurality of layers define a hooking region in which the plurality of layers are bent in a hook configuration, the hooking region located at an end of the longitudinal region and configured to be secured to another hooking region of another ventilation conduit section.

In another aspect of the invention, the periodic pattern of the longitudinal region may be a sinusoidal pattern having a first amplitude. The plurality of layers may further define two periodic layers, the two periodic layers each comprising at least one layer of the plurality of layers and each defining a periodic pattern along the length of the longitudinal region, the periodic pattern of a first of the two periodic layers having a smaller amplitude than the amplitude of a second of the two periodic layers. The two periodic layers may be in connection with one another at the lowest point of their respective period only.

In another aspect of the invention, the plurality of layers may bend inwardly so that an end of the plurality of layers faces towards the longitudinal region. The first of the two periodic layers ay end at the hooking region and the second of the two periodic layers may continue past the hooking region as a periodic layer of another ventilation conduit section. A third periodic layer of another ventilation conduit section may start at the hooking region over the second of the periodic layers, wherein the second of the two periodic layers is configured to become a first of the two periodic layers in the other ventilation conduit section.

In yet another aspect of the invention, a layer made of a second material covers the plurality of layers of the first material. The layer of the second material may have a sinusoidal pattern having a second amplitude that is smaller than the amplitude. The first material may be any one of galvanized steel, aluminum or stainless steel. The second material may have anti-corrosion properties. The second material may be a polymer-based material. The layer of the second material may be hot-melted over the plurality of layers of the first material.

In another aspect of the invention, the plurality of layers may be coated with an anti-corrosion coating. A thermal insulation membrane covering the layer of the second material may further be provided. The thermal insulation membrane may be bubble wrap.

In another aspect of the invention, the bent configuration of the hooking region may provide sealing between the ventilation conduit section and another ventilation conduit section. The plurality of layers may further fine a second hooking region in which the plurality of layers are bent in a hook configuration, the second hooking region located at an end of the longitudinal region opposite to the end of the first hooking region and configured to be secured to another hooking region of another ventilation conduit section.

In another aspect of the invention, a ventilation conduit comprising a plurality of ventilation conduit sections secured to one another at the hooking regions is provided. A layer being made of a second material having anti-corrosion properties may cover the plurality of layers of the first material of the plurality of ventilation conduit sections. The ventilation conduit may further comprise an attachment system configured to secure the ventilation conduit to an external peripheral or to another ventilation conduit, the attachment system comprising an elastic band secured around one of the sections of the ventilation conduit and a hook, the hook securing the elastic band to the external peripheral or to the other ventilation conduit. The ventilation conduit may further comprise a thermal insulation membrane covering the layer of the second material.

In another aspect of the invention, a method manufacturing a ventilation conduit is provided, the method comprising the steps of: processing a first material through a series of dies to obtain a resulting profile; processing the first material in a hook configuration; wrapping the resulting profile around a tool to create the shape of a ventilation duct; processing the first material in accordance with the geometric requirements of the ventilation duct; applying a layer of a second material having anti-corrosion properties over the first material using a hot melt adhesive and heating the second material to increase its properties. The method may further comprise: securing an elastic band to the ventilation duct and hooking a hook to the elastic band and to an external peripheral for installation of the ventilation duct on-site. The method may further comprise spraying an anti-corrosion coat on the first material. The method may further comprise covering the layer of the second material with a thermal insulation membrane.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is showing a side sectional view of a full profile of a ventilation conduit in accordance with the principles of the present invention.

FIG. 2A is showing a side sectional view of a profile of a ventilation conduit in accordance with the principles of the present invention.

FIG. 2B is showing a bottom perspective view of the profile of the ventilation conduit of FIG. 1A.

FIG. 2C is showing a side sectional view of the sealing of the profile of the ventilation conduit of FIG. 1A.

FIG. 3A is showing a side sectional view of a profile of another ventilation conduit in accordance with the principles of the present invention.

FIG. 3B is showing a bottom perspective view of the profile of the ventilation conduit of FIG. 3A.

FIG. 3C is showing a side sectional view of the sealing of the profile of the ventilation conduit of FIG. 3A.

FIG. 4 is showing a side sectional view of another completed profile of a ventilation conduit in accordance with the principles of the present invention.

FIG. 5 is illustrating a method of manufacturing a ventilation duct in accordance with the principles of the present invention.

### DETAILED DESCRIPTION OF THE PREFERRED EMBODIMENT

A novel ventilation conduit will be described hereinafter. Although the invention is described in terms of specific illustrative embodiment(s), it is to be understood that the embodiment(s) described herein are by way of example only and that the scope of the invention is not intended to be limited thereby.

The ventilation conduit 100, also referred to as ventilation duct, duct or tube, is a semi-rigid duct that is adapted to be manufactured with varying lengths and dimensions depending on the installation configuration required in a building structure. The ventilation conduit 100 is configured to be installed in the structure of a building, generally attached to metal grids, before being covered by poured concrete. The ventilation conduit 100 is also configured to resist corrosion from the poured concrete or from humidity.

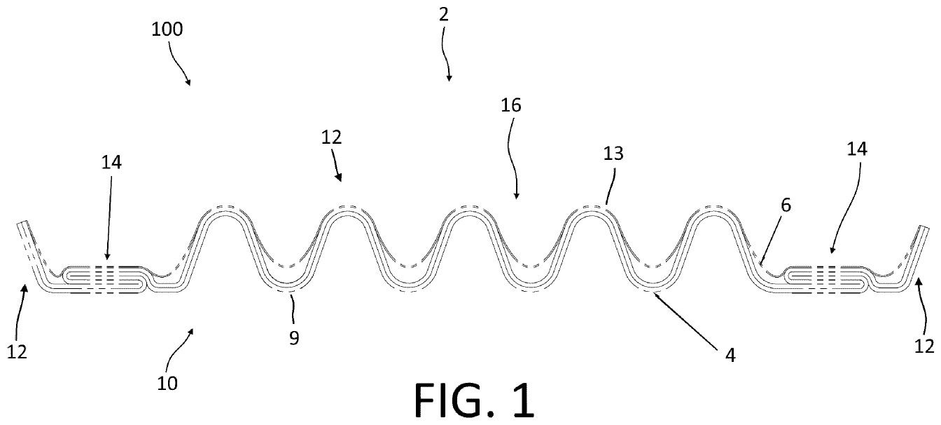

In a first embodiment shown in FIG. 1, an exemplary embodiment of a side profile of a ventilation conduit 100 is provided. The ventilation duct 100 comprises a circular section 2 of a certain length that forms a pipe, tube or duct, and having a first material 4 and a second material 6 bent together. The first material 4 may be galvanized steel, aluminum, stainless steel or any other material used in ventilation ducts installed in concrete slabs known in the art. In an embodiment of the invention, the first material 4 is galvanized steel (stainless steel 316L is an option). The first material 4 is configured to be facing the inside of the ventilation conduit 100. The thickness of the first material 4 may vary depending on the required properties of the duct 100. In preferred embodiments, the first material 4 has a thickness between 0.004 and 0.006 inches. Understandably, the thickness of the first material 4 may be under 0.004 inches and over 0.006 inches. The second material 6 may be a polymer-based membrane or any other membrane efficient against corrosion that is known in the art. The second material 6 is configured to be at least semi-rigid and to have strong anti-corrosion properties. The second material 6 is configured to be facing the outside of the ventilation conduit 100, and may thus generally be in contact with concrete, wire mesh, etc. The thickness of the second material 6 may vary depending on the required properties of the duct 100. In preferred embodiments, the second material 6 has a thickness between 0.0003 and 0.0007 inches. Understandably, the thickness of the first material 4 may be under 0.0003 inches and over 0.0007 inches.

Still referring to FIG. 1, the profile of the ventilation conduit 100 is shown with a protective layer 6, or top layer, added over the plurality of layers of the first material 4. The protective layer 6 is comprised of the second material; as such, it may be a polymer-based material having corrosion resistance properties. The top layer 6 may be added on top of the layers of the first material 4 with a hot melt adhesive. Understandably, any other method of securing the protective layer 6 to the layers of the first material 4 may be used. The protective layer 6 may be installed over only one section 2 of a ventilation duct 100 or over multiple adjacent sections 2 of a ventilation duct 100. It may be appreciated that an anti-corrosion coating 9 may be coated on the first material 4 to provide further anti-corrosion properties to the inside of the ventilation duct 100. Furthermore, a thermal insulation membrane 13 may be added over the top layer 6 to prevent or reduce heat conduction between the inside and outside of the ventilation conduit 100. In another embodiment, the thermal insulation membrane 13 may be added between any of the plurality of layers of the first 4 or second material 6. In an embodiment of the invention, the thermal insulation membrane 13 may have a length of 2 to 3 meters along the length of the ventilation conduit 100. In yet another embodiment, the thermal insulation membrane 13 may be bubble wrap or any other material known in the art used for insulation in building ventilation.

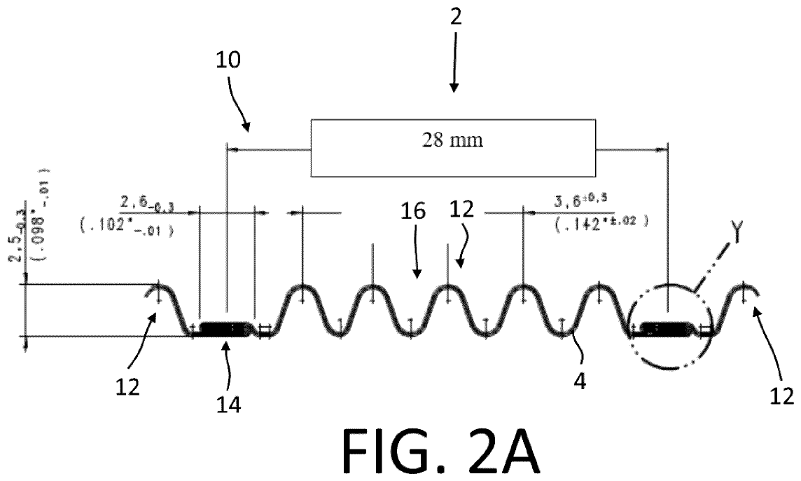

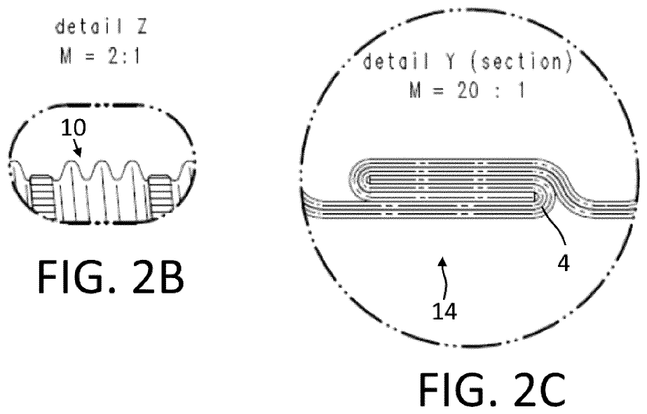

Now referring to FIGS. 2A to 2C, an embodiment of a first profile 10 of the section 2 of the ventilation duct 100 is shown. The first profile 10 represents a section 2 of the pipe of the ventilation duct 100 before being rolled in a circular shape. The section 2 comprises a plurality of layers of the first material 4. The section 2 is further configured to comprise subsections 12 having a hooking region 14 and a longitudinal region 16. In the longitudinal region 16, a plurality of layers 4 set on top of each other's may span a length of a certain distance. For example, in one embodiment, the longitudinal region 16 has a length of approximately 28 mm. Understandably, the length of the longitudinal region 16 may be under or over 28 mm. The layers 4 of the longitudinal region 16 are bent in a periodical pattern. In the embodiment shown, the layers 4 of the longitudinal region 16 are bent in a sinusoidal wave. In a preferred embodiment, the period of the sinusoidal wave is of 0.05 inches, the displacement of the sinusoidal wave is of 0.1 inches and the length of the longitudinal subsection 16 may be of approximately 1.10 inches. Understandably, having lower or higher periods or length of longitudinal subsections 16 may vary the properties of the section 2. In the hooking region 14, the extremity of two subsections 12 may be attached together in a hook configuration. The layers 4 of the hooking region are bent in a configuration allowing hooking with other similar layers 4 of another subsection 12. In a preferred embodiment, the length of the hooking region 14 is of approximately 0.1 inches. It may be understood that the hooking regions 14 may provide continuity to the length of the section 2 while also providing sealing between each of the subsections 12.

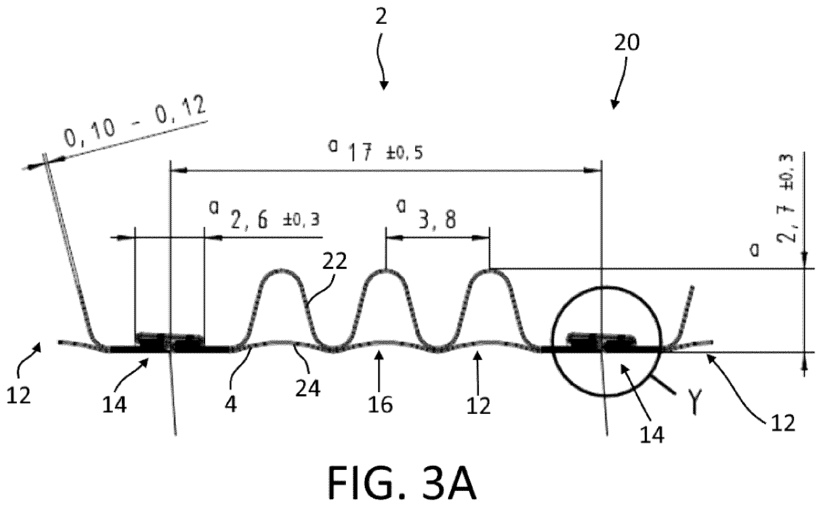

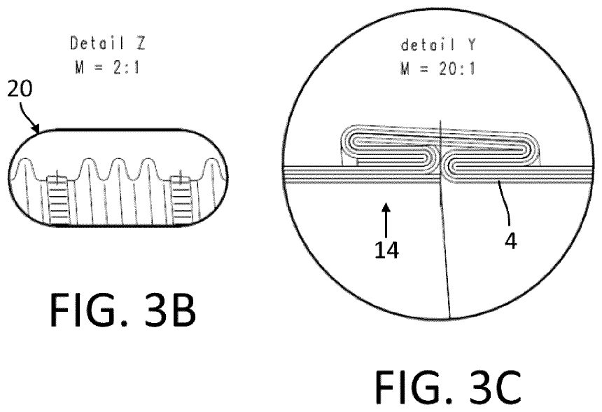

Now referring to FIGS. 3A to 3C, an embodiment of a second profile 20 of the section 2 of the ventilation duct 100 is shown. Similarly to the first profile 10, the second profile 20 represents a section 2 of the pipe of the ventilation duct 100 having a plurality of subsections 12, each subsection 12 being comprised of a plurality of layers 4, each of the layers 4 being comprised of the first material. The main difference compared to the first profile 10 is that the longitudinal 16 and hooking 14 regions have different configurations. The longitudinal region 16 comprises two layers (22, 24) of the first material 4, the first 22 being configured to make a periodical pattern such as a sinusoidal wave and the second 24 being configured to make a periodical pattern with a displacement much smaller than the displacement of the first layer 22. Both of the layers (22, 24) may be in connection at the lowest height of their period. In a preferred embodiment, the period of the sinusoidal wave is of 0.15 inches, the displacement of the sinusoidal wave is of 0.1 inches and the length of the longitudinal region 16 may be of approximately 0.7 inches. Understandably, having lower or higher periods or length of longitudinal region 16 may vary the properties of the section 2. It may further be understood that any other configuration may comprise more than two layers (22, 24). In the hooking region 14, the extremity of two subsections 12 are attached together in a hook configuration. The layers 4 of the hooking region are bent in a configuration allowing hooking with other similar layers 4 of other subsections 12. In a preferred embodiment, the length of the hooking region 14 is of approximately 0.1 inches. It may be understood that the hooking regions 14 may provide continuity to the length of the section 2 while also providing sealing between each of the subsections 12.

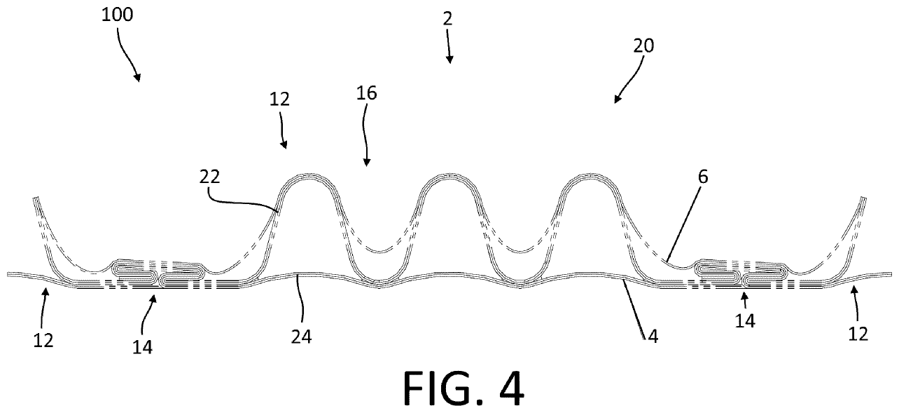

Referring now to FIG. 4, the second profile 20 of FIGS. 3A to 3C is shown with a protective layer 6, or top layer, added over the plurality of layers of the first material 4. The protective layer 6 is comprised of the second material; as such, it may be a polymer-based material having corrosion resistance properties. The top layer 6 may be added on top of the layers of the first material 4 with a hot melt adhesive. Understandably, any other method of securing the protective layer 6 to the layers of the first material 4 may be used. The protective layer 6 may be installed over only one section 2 of a ventilation duct 100 or over multiple adjacent sections 2 of a ventilation duct 100. It may be further understood that the top layer 6 may be installed over the first profile 10.

In other embodiments of the invention, the ventilation duct 100 may be attached to other ventilation ducts 100 or to any other peripheral of a building structure with an attachment system 30, not shown. The attachment system 30 comprises an elastic 32 set up around the circumference of the ventilation duct 100 and of at least a hook 34. The elastic 32 may be custom-made to have dimensions in accordance with the dimensions of the ventilation duct 100 to be installed on. The hooks 34 may be attached to the elastic 32 on one end and to the external peripheral, such as a metal grid, or to the elastic 32 of another ventilation duct 100 on the other end. It may be understood that using the above-described attachment system 30 allows for quick installation and uninstallation of a ventilation duct 100 without the requirement of tools or complex installation steps. In a preferred embodiment, the elastic 32 is a heavy duty elastic.

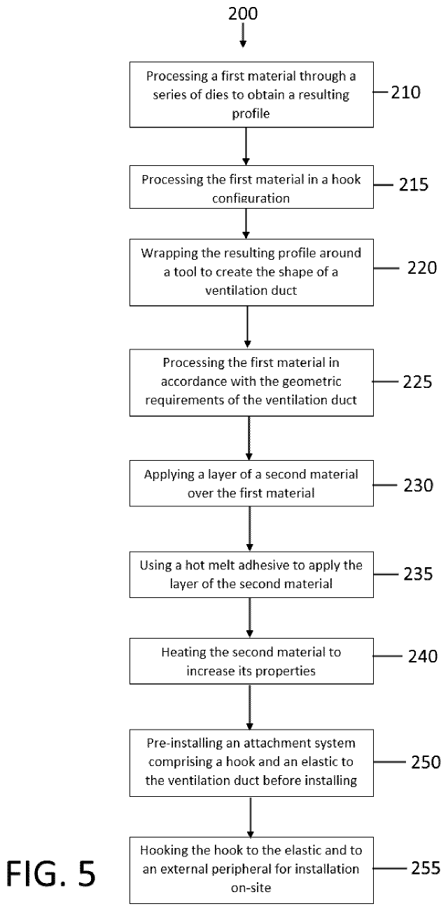

Now referring to FIG. 5, a method 200 for manufacturing and installing a ventilation conduit is provided. The method comprises the following steps. A first material, generally starting as a plurality of sheets of predetermined dimensions, is processed through a series of dies to obtain the resulting profiles as seen in any one of FIGS. 2A to 2C and 3A to 3C 210. It may be appreciated that the sheets are processed to lock with other sheets in a “hook” configuration as seen in FIGS. 2C and 3C 215. The formed profile may then be wrapped around a tool, such as a mandrel, to substantially create the shape of the ventilation duct 220. The mandrel allows the user processing the first material to select the diameter and geometric parameters of the duct in accordance with the requirements of the final installation 225. With the use of a mandrel to create the shape of the duct, the different sheets used to create the first material may further be bent together in order to create a continuous seal along the circumference of the duct. Once the first material has been processed to have the shape of the duct and the resulting duct is removed from the mandrel, a layer of the second material is wrapped around the resulting duct 230. A hot melt adhesive may be added to the second material for efficient connection to the first material 235. Furthermore, the second material may be heated to increase some of its properties, such as its flexibility 240. The attachment system may further be pre-installed to the ventilation duct by a machine before the duct is installed on site to save time 250. The attachment system may further be installed to the ventilation duct on site by hooking one end of a hook to an elastic installed around a ventilation duct and hooking the other end of the hook to an external peripheral such as a metal wire 255. Understandably, even though the ventilation duct comprises a first material that is generally non-flexible in voluminous applications, the pattern of the first and second profiles, the thickness and the combination with the second semi-flexible or flexible material may allow the resulting ventilation duct to be flexible and to be flexed in various configurations. It may further be appreciated that, by using a mandrel tool to create the shape of the ventilation duct, a smooth interior may result from the processing, thus reducing friction in air streams circulating inside said ventilation duct.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A ventilation conduit section, the section comprising:
a plurality of layers stacked on top of one another, the layers being made of a first material; and
a layer being made of a second material having anti-corrosion properties covering the plurality of layers of the first material,
wherein the plurality of layers define a longitudinal region having a periodic pattern along a length,
the plurality of layers define a hooking region in which the plurality of layers are bent in a hook configuration, the hooking region located at an end of the longitudinal region and configured to be secured to another hooking region of another ventilation conduit section.

2) The ventilation conduit section of claim 1, the periodic pattern of the longitudinal region being a sinusoidal pattern having a first amplitude.

3) The ventilation conduit section of claim 1, the plurality of layers further defining two periodic layers, the two periodic layers each comprising at least one layer of the plurality of layers and each defining a periodic pattern along the length of the longitudinal region, the periodic pattern of a first of the two periodic layers having a smaller amplitude than the amplitude of a second of the two periodic layers.

4) The ventilation conduit section of claim 3, the two periodic layers being in connection with one another at the lowest point of their respective period only.

5) The ventilation conduit section of claim 1, the plurality of layers bending inwardly so that an end of the plurality of layers faces towards the longitudinal region.

6) The ventilation conduit section of claim 3, the first of the two periodic layers ending at the hooking region and the second of the two periodic layers continuing past the hooking region as a periodic layer of another ventilation conduit section.

7) The ventilation conduit section of claim 6, a third periodic layer of another ventilation conduit section starting at the hooking region over the second of the periodic layers, wherein the second of the two periodic layers is configured to become a first of the two periodic layers in the other ventilation conduit section.

8) The ventilation conduit section of claim 1, the layer of the second material having a sinusoidal pattern having a second amplitude that is smaller than the amplitude.

9) The ventilation conduit section of claim 1, the first material being any one of galvanized steel, aluminum or stainless steel.

10) The ventilation conduit section of claim 1, the second material being a polymer-based material.

11) The ventilation conduit section of claim 10, the layer of the second material being glued to the plurality of layers of the first material with an adhesive.

12) The ventilation conduit section of claim 11, the adhesive being holt-melted.

13) The ventilation conduit section of claim 1, the plurality of layers being coated with an anti-corrosion coating.

14) The ventilation conduit section of claim 1, comprising a thermal insulation membrane covering the layer of the second material.

15) The ventilation conduit section of claim 1, the bent configuration of the hooking region providing sealing between the ventilation conduit section and another ventilation conduit section.

16) The ventilation conduit section of claim 1, the plurality of layers further defining a second hooking region in which the plurality of layers are bent in a hook configuration, the second hooking region located at an end of the longitudinal region opposite to the end of the first hooking region and configured to be secured to another hooking region of another ventilation conduit section.

17) A ventilation conduit comprising a plurality of ventilation conduit sections according to claim 16 secured to one another at the hooking regions, the ventilation conduit being flexible.

18) The ventilation conduit of claim 17, the layer being made of a second material covering the plurality of layers of the first material of the plurality of ventilation conduit sections.

19) The ventilation conduit of claim 17, comprising a thermal insulation membrane covering the layer of the second material.

20) The ventilation conduit of claim 17, the ventilation conduit further comprising an attachment system configured to secure the ventilation conduit to an external peripheral or to another ventilation conduit, the attachment system comprising an elastic band secured around one of the sections of the ventilation conduit and a hook, the hook securing the elastic band to the external peripheral or to the other ventilation conduit.

21) A method manufacturing a ventilation conduit, the method comprising the steps of:
i. processing a first material through a series of dies to obtain a resulting profile;
ii. processing the first material in a hook configuration;
iii. wrapping the resulting profile around a tool to create the shape of a ventilation duct;
iv. processing the first material in accordance with the geometric requirements of the ventilation duct;
v. applying a layer of a second material having anti-corrosion properties over the first material using a hot melt adhesive;
vi. heating the second material to increase its properties.

22) The method of claim 21, the method further comprising:
i. securing an elastic band to the ventilation duct;
ii. hooking a hook to the elastic band and to an external peripheral for installation of the ventilation duct on-site.

23) The method of claim 21, the method further comprising:
i. spraying an anti-corrosion coat on the first material.

24) The method of claim 21, the method further comprising:
i. covering the layer of the second material with a thermal insulation membrane.
